(19) United States
(12) Patent Application Publication
(10) Pub. No.: US 2024/0130926 A1
(43) Pub. Date: Apr. 25, 2024

(54) MUSCLE FITNESS RELAXATION DEVICE

(71) Applicant: Soonly marketing consulting company, Taipei City (TW)

(72) Inventor: Yao-Ken HUNG, Taichung City (TW)

(21) Appl. No.: 18/490,214

(22) Filed: Oct. 18, 2023

(30) Foreign Application Priority Data
Oct. 19, 2022 (TW) 111139895

(51) Int. Cl. A61H 15/00

(52) U.S. Cl. CPC A61H 15/00; A61H 2015/0014; A61H 2201/1284

(57) ABSTRACT

A muscle fitness relaxation device includes at least two roller units spaced apart from each other along a longitudinal direction, and at least one connecting unit connected between the roller units. Each of the roller units extends along an axis perpendicular to the longitudinal direction, and has an outer peripheral surface extending around the axis.

### CROSS-REFERENCE TO RELATED APPLICATION

This application claims priority to Taiwanese Invention Patent Application No. 111139895, filed on Oct. 20, 2022, the entire disclosure of which is incorporated by reference herein.

### FIELD

The present disclosure relates to a yoga instrument, and more particularly to a muscle fitness relaxation device.

### BACKGROUND

A yoga roller disclosed in Taiwanese Patent No. M523474 includes an inner tube, an outer tube sleeved on an outer surface of the inner tube, and two cover bodies respectively connected to two opposite ends of the inner tube and respectively located on two opposite sides of the outer tube.

When performing a yoga exercise, the yoga roller is used to protect and guide a human body to perform a variety of yoga poses. Various properties of the yoga roller including softness and flexibility allow the yoga roller to be placed against a user's back or waist. The user may slide back and forth on the yoga roller, and the user's back, lumbar bone and nerves, lymph glands, etc. may thus be massaged.

This type of yoga roller only provides support for a single area, and the user may also need to use a yoga ball or other auxiliary devices in conjunction with the yoga roller to perform other activities. However, in practice, the yoga roller and the auxiliary devices are separate items, so these activities may not be streamlined.

Moreover, the auxiliary devices may occupy space when not being used.

### SUMMARY

Therefore, an object of the disclosure is to provide a muscle fitness relaxation device that can alleviate at least one of the drawbacks of the prior art.

According to the disclosure, the muscle fitness relaxation device includes at least two roller units spaced apart from each other along a longitudinal direction, and at least one connecting unit connected between the roller units. Each of the roller units extends along an axis perpendicular to the longitudinal direction, and has an outer peripheral surface extending around the axis.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a partly exploded perspective view of a first embodiment of the muscle fitness relaxation device according to the present disclosure.

FIG. 2 is a perspective view of the first embodiment in an assembled state.

FIG. 3 is a schematic view illustrating an operation of the first embodiment.

FIG. 4 is a schematic view illustrating another operation of the first embodiment.

FIG. 5 is a schematic view illustrating a second embodiment of the muscle fitness relaxation device according to the present disclosure.

FIG. 6 is an assembled perspective view of a third embodiment of the muscle fitness relaxation device according to the present disclosure.

FIG. 7 is a schematic view illustrating an operation of the third embodiment.

FIG. 8 is an assembled perspective view of a fourth embodiment of the muscle fitness relaxation device according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

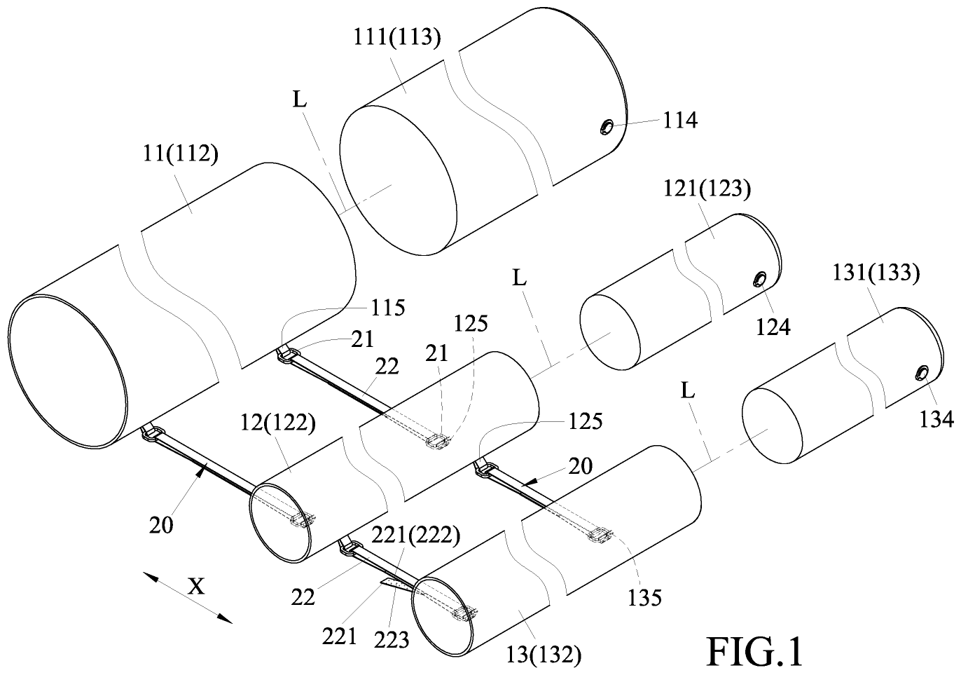

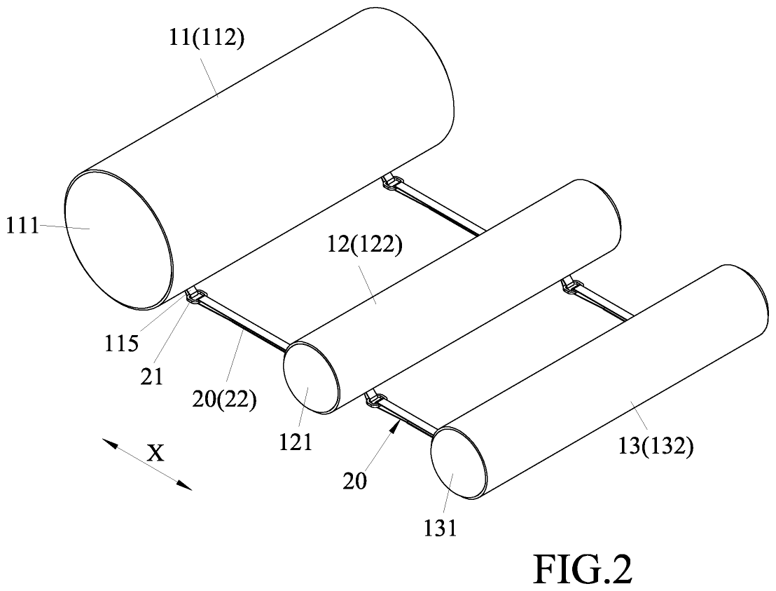

Referring to FIGS. 1 and 2, the first embodiment of the muscle fitness relaxation device according to the present disclosure includes three roller units 11, 12, 13 and two connecting units 20.

The roller units 11, 12, 13 are spaced apart along a longitudinal direction (X). Each of the roller units 11, 12, 13 extends along an axis (L) perpendicular to the longitudinal direction (X), and includes an air-fillable inner tube member 111, 121, 131, and a covering sleeve 112, 122, 132 detachably covering an outer side of the inner tube member 111, 121, 131. The inner tube member 111, 121, 131 of each of the roller units 11, 12, 13 has an outer peripheral surface 113, 123, 133 extending around its own axis (L), and an inflatable and deflatable air valve 114, 124, 134. In this embodiment, an outer diameter of one of the roller units 11 perpendicular to its own axis (L) is greater than an outer diameter of each of the remaining roller units 12, 13 perpendicular to its own axis (L). Each of the covering sleeves 112, 122, 132 is made of flannel, and has two hollow ends for easy assembly and disassembly with the corresponding inner tube member 111, 121, 131. In one embodiment, each of the covering sleeves 112, 122, 132 has at least one pair of link plates 115, 125, 135.

Each connecting unit 20 is connected between two adjacent roller units 11, 12 (or roller units 12, 13). Each connecting unit 20 is adjustable in length along the longitudinal direction (X), so the distance between the roller units 11, 12, 13 may be adjusted. In this embodiment, each connecting unit 20 has two pairs of engaging members 21 respectively disposed on the link plates 115, 125 of the two roller units 11, 12 (or link plates 125, 135 of the roller units 12, 13), and two strap bodies 22 extending through the engaging members 21 and extending along the longitudinal direction (X). Each of the strap bodies 22 has two movable end portions 221, a male hook-and-loop fastener 222 disposed on one of the movable end portions 221, and a female hook-and-loop fastener 223 disposed on the other one of the movable end portions 221 and engageable with the male hook-and-loop fastener 222.

To further understand the effect produced, the technical means for utilizing, and the expected effect of the cooperation of the components of this disclosure, the following is once again a detailed description of the disclosure so that a more in-depth and specific understanding of this disclosure may be obtained thereby.

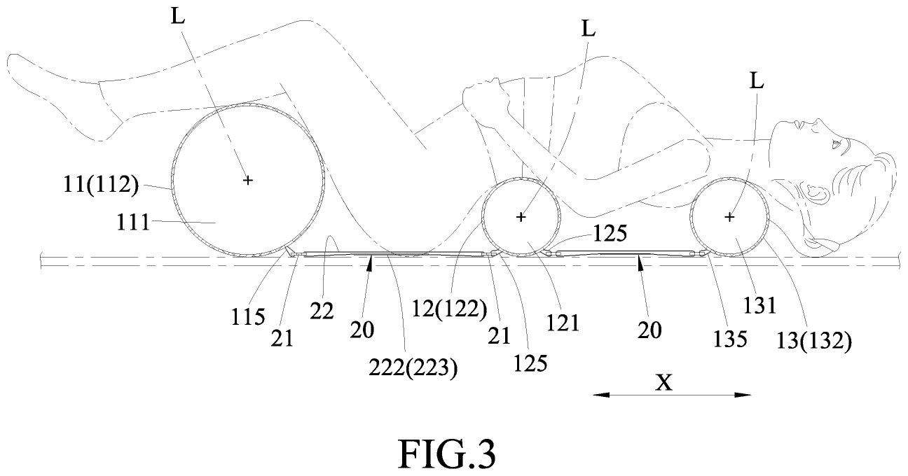

Referring to FIGS. 1 and 3, when the muscle fitness relaxation device of the present disclosure is completely assembled and is ready to be used, the roller unit 11 having the greatest outer diameter is located at one side of the muscle fitness relaxation device, and the other two roller units 12, 13 (having smaller outer diameters) are spaced apart from each other along the longitudinal direction (X) and are disposed on one side of the roller unit 11 having the greatest outer diameter.

By virtue of the length along the longitudinal direction (X) of the connecting units 20 being adjustable, the distance between the roller units 11, 12, 13 may be adjusted according to the user's body measurements. Furthermore, when adjusting the distance between the roller units 11, 12, 13, only the male hook-and-loop fastener 222 of each of the strap bodies 22 and the corresponding female hook-and-loop fastener 223 are to be disengaged or re-engaged, so the adjustment is easy.

When the user places his/her leg on the roller unit 11 having the greatest outer diameter and rests his/her waist on the roller unit 12 having the smaller outer diameter located at the middle, his/her neck is then rested on the roller unit 13 having the smaller outer diameter located at one side of the roller unit 12 along the longitudinal direction (X). Furthermore, by using the covering sleeves 112, 122, 132 made of flannel, the roller unit 11 is anti-slippery.

When the user uses the roller unit 11 having the greatest outer diameter as a fulcrum with his/her legs and slides his/her body back and forth along the longitudinal direction (X), the roller units 12, 13 may be used to assist the movement of the user. By virtue of the connecting units 20 being connected among the roller units 11, 12, 13, the roller units 11, 12, 13 may be operated smoothly to massage the user's meridians, muscles, hips, waist, back, and shoulder, and to relax his/her bones, nerves, lymph glands, etc.

In addition, when the user places his/her legs on the roller unit 11 having the greatest outer diameter, the range within which his/her body slides back and forth along the longitudinal direction (X) may be controlled so that over rolling is avoided.

Therefore, the muscle fitness relaxation device of this disclosure utilizes the roller units 11, 12, 13 to provide positioning for the user's legs, waist and neck, and the connection between the roller units 11, 12, 13 using the connecting units 20 allows the user to streamline his/her activities and achieve better health.

It should be noted that the roller units 11, 12, 13 of this disclosure utilize the inner tube members 111, 121, 131 each having the air valves 114, 124, 134 capable of being inflated and deflated, so that an inflated degree and outer diameter of the inner tube member 111, 121, 131 may be adjusted according to different requirements.

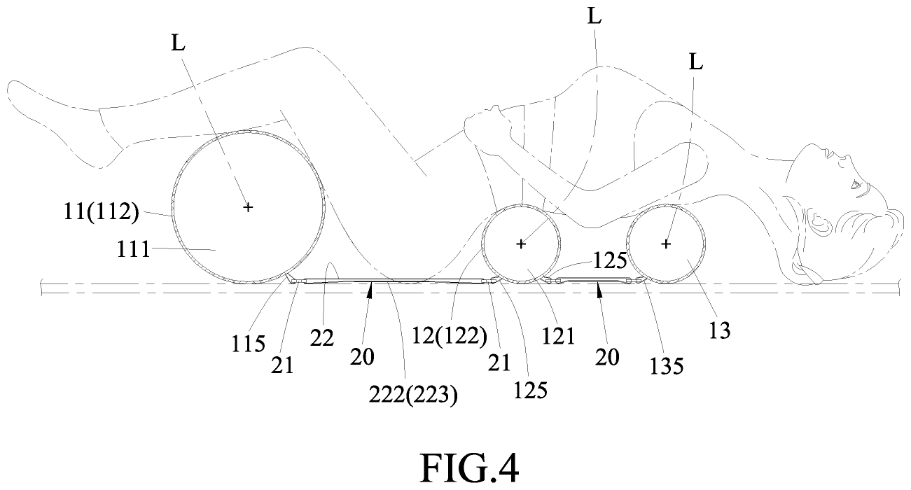

As shown in FIG. 4, when the distance between two of the roller units 12, 13 are adjusted such that the roller units 12, 13 are brought into position to support the user's waist and back, respectively, the purpose of a workout routine may also be achieved.

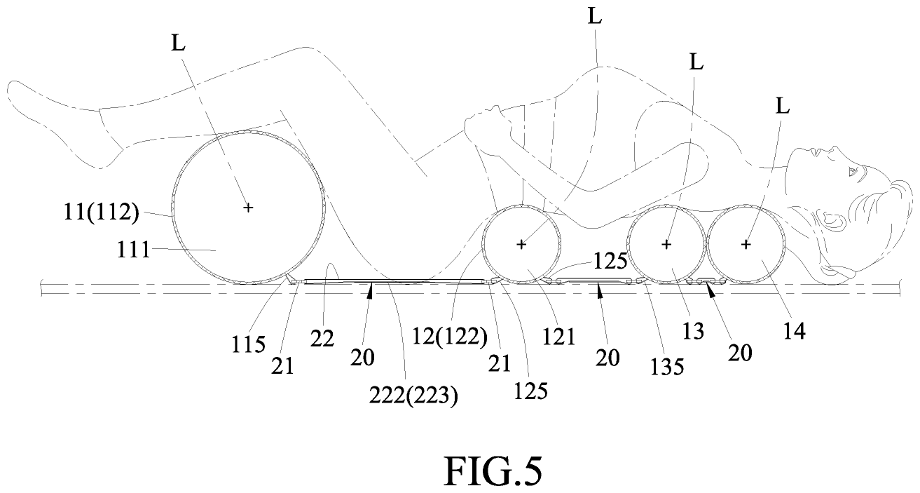

Referring to FIG. 5, a second embodiment of the muscle fitness relaxation device according to this disclosure includes four roller units 11, 12, 13, 14 and three connecting units 20. This embodiment differs from the first embodiment in that another roller unit 14 having a smaller outer diameter and another connecting unit 20 are added. By using the roller units 11, 12, 13, 14 for positioning and supporting the user's legs, waist, back, and neck, respectively, the purpose of the workout routine may also be achieved.

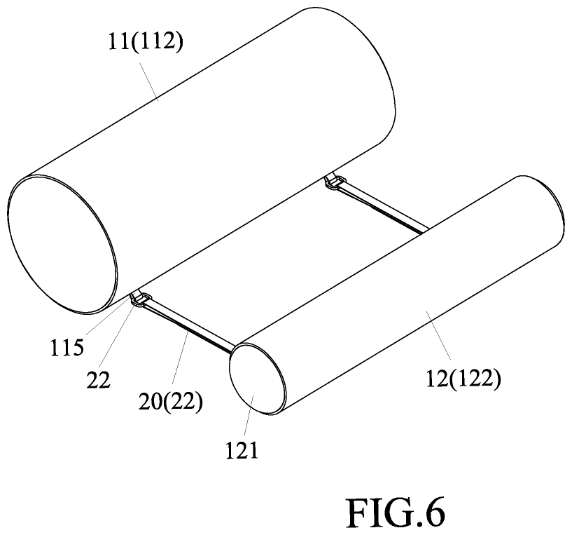

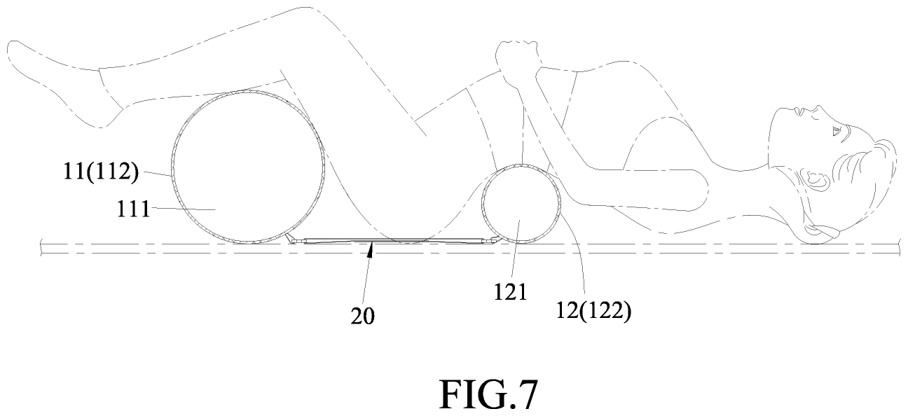

Referring to FIGS. 6 and 7, a third embodiment of the muscle fitness relaxation device according to the present disclosure includes two roller units 11, 12 and a connecting unit 20. The difference between the third embodiment and the first embodiment is that, in the third embodiment, one of the roller units with a smaller outer diameter and one of the connecting units 20 are omitted.

In the third embodiment of the muscle fitness relaxation device, the user may place his/her legs on the roller unit 11 having the largest outer diameter, rest his/her waist on the roller unit 12 having the smaller outer diameter, and rest his/her head on the ground (or a yoga mat), thereby achieving the purpose of the workout routine.

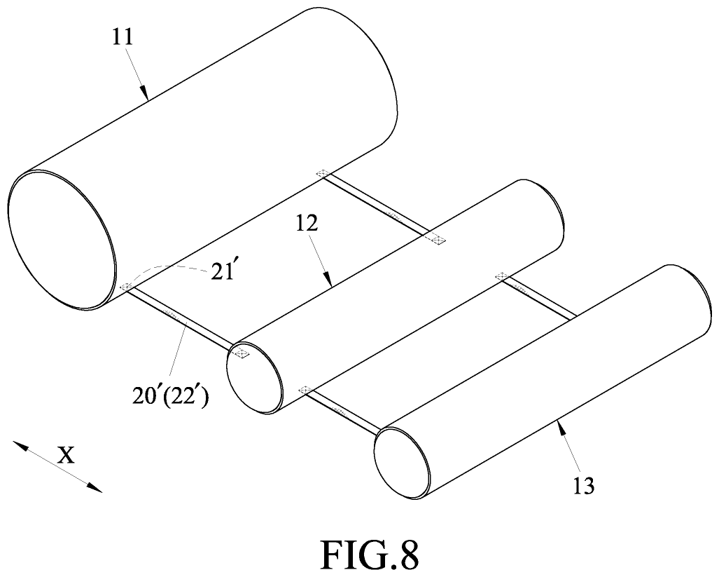

Referring to FIG. 8, a fourth embodiment of the muscle fitness relaxation device according to this disclosure differs from the first embodiment in that the link plates 115, 125, 135 are omitted. Each of the connecting units 20′ includes two pairs connecting plates 21′ respectively disposed on two roller units 11, 12 (or the roller units 12, 13), and two elastic strap bodies 22′ each being sewn between two of the connecting plates 21′. Each of the strap bodies 22′ extends along the longitudinal direction (X). Furthermore, by virtue of of the strap bodies 22′ being elastic, the fourth embodiment is suitable for various users each having different body measurements, thereby achieving the purpose of the workout routine.

In summary, the muscle fitness relaxation device of this disclosure has a simple structure, is easy to be manufactured, and may achieve various purposes of the workout routine, so the object of this disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A muscle fitness relaxation device comprising:
at least two roller units spaced apart from each other along a longitudinal direction, each of said roller units extending along an axis perpendicular to the longitudinal direction and having an outer peripheral surface that extends around the axis; and
at least one connecting unit connected between said roller units.

2. The muscle fitness relaxation device as claimed in claim 1, wherein each of said roller units includes an inflatable inner tube member, and a covering sleeve removably covering an outer side of said inner tube member, said inner tube member of each of said roller units having an inflatable and deflatable air valve.

3. The muscle fitness relaxation device as claimed in claim 1, comprising three of said roller units, and two of said connecting units.

4. The muscle fitness relaxation device as claimed in claim 1, wherein one of said roller units has an outer diameter perpendicular to the axis greater than an outer diameter of the other one of said roller units.

5. The muscle fitness relaxation device as claimed in claim 3, wherein one of said roller units has an outer diameter perpendicular to the axis greater than an outer diameter of each of the other two of said roller units.

6. The muscle fitness relaxation device as claimed in claim 1, wherein said connecting unit is adjustable in length along the longitudinal direction for adjusting a distance between said roller units.

7. The muscle fitness relaxation device as claimed in claim 1, wherein said connecting unit includes at least two pairs of engaging members respectively disposed on said roller units, and two strap bodies extending through said engaging members and extending along the longitudinal direction, each of said strap bodies having two movable end portions, a male hook-and-loop fastener that is disposed on one of said movable end portions, and a female hook-and-loop fastener that is disposed on another one of said movable end portions and that is engageable with said male hook-and-loop fastener.

8. The muscle fitness relaxation device as claimed in claim 1, wherein said connecting units includes at least two pairs of connecting plates respectively disposed on said roller units, and two elastic strap bodies each being sewn between two of said connecting plates and extending along the longitudinal direction.

9. The muscle fitness relaxation device as claimed in claim 1, comprising four of said roller units, and three of said connecting units.
